(19) United States
(12) Patent Application Publication
(10) Pub. No.: US 2004/0187657 A1
(43) Pub. Date: Sep. 30, 2004

(54) O.D. mount facing machine

(75) Inventor: Jeffery A. Smith, Baytown, TX (US)

Correspondence Address: Mark R. Wisner, c/o Wisner & Associates, Suite 400, 1177 West Loop South, Houston, TX, 77027, US

(73) Assignee: Meridian Equipment, Inc.

(21) Appl. No.: 10/395,928

(22) Filed: Mar. 24, 2003

(51) Int. Cl. B23B 3/00

(52) U.S. Cl. 82/123

(57) ABSTRACT

An apparatus for reconditioning the surface of a workpiece. The frame of the apparatus includes a first portion that is frictionally engaged to the outside diameter of the workpiece and a second portion that rotates relative to the first portion. A cutting tool is mounted to the rotating portion of the frame, and in addition to providing for the alignment of the frame with the workpiece, the present invention provides for the squaring up of the frame with the surface of the workpiece that is to be reconditioned so that the cutting tool will provide a flat, finished surface that is perpendicular to the longitudinal axis of the workpiece. Also provided is a mount for the cutting tool that facilitates fast replacement of the cutting tool while still allowing precise positioning of the cutting tool and minimizing any relative movement between the cutting tool and the mount.

### BACKGROUND OF THE INVENTION

The present invention relates to machining equipment. More specifically, the present invention relates to an apparatus and method for reconditioning the surface of a workpiece, such as a gasket surface, and is particularly useful for reconditioning such surfaces in the field.

It is known to detachably mount a so-called ring, or facing, machine to, for instance, a pipe or other tubular member for reconditioning the surface, or facing, of the pipe that mates to another surface. Such machines are comprised of a ring or frame that is mounted to the outside diameter, or O.D., of the pipe or tubular member having a movable member mounted thereto to which a cutting tool is mounted for re-facing, or reconditioning, the surface of the pipe or tubular member.

There are a number of difficulties with the use of such a machine, including the need for precision in the cutting process for reconditioning the surface, the heavy weight of the ring machine, the mounting of the ring machine to the O.D. of the pipe or tubular member in a position that is both aligned with the pipe and squared up to the surface to be reconditioned, and the need for secure mounting of the cutting tool to the ring machine. This list is not intended to be exhaustive, but will serve for the purpose of illustrating some of the difficulties in the use of such machines.

There are at least two difficulties with prior ring machines to which the present invention is particularly addressed. First with regard to the difficulty in mounting such machines to the pipe or tubular member, there is a need for an apparatus and method of aligning the machine with both the axis of the tubular member and the surface to be reconditioned. In this regard, it is known to use multiple clamps or fixtures to mount the ring machine to the outside diameter of the tubular member, and to use the clamps for minute movement of the ring machine needed to “center” the ring machine on the tubular member. Such centering movement is accomplished by loosening the clamp(s) on one side of the tubular member and tightening the clamps on the other side of the tubular member with the result that the ring member is re-positioned relative to the tubular member. The distance between the O.D. of the tubular member and the ring member is then measured, for instance, using a dial gauge, and then, by repeated loosening and tightening to correct any misalignment between tubular member and ring machine, the ring machine is gradually aligned with the tubular member.

This process, however, only aligns the center axis of the ring machine with the center axis of the tubular member. It does not square the ring machine up to the surface to be reconditioned. Stated another way, if an X, Y, Z coordinate system is superimposed on the surface to be reconditioned with the X and Y axes lying in the plane of the surface to be reconditioned and the substantially perpendicular Z axis is substantially parallel to the longitudinal axis of the tubular member, conventional ring machines are aligned with the tubular member by moving the ring member in directions substantially in the plane of (or referred to herein as being “substantially parallel” or “having a directional component substantially parallel to”) the X and Y axes by this process of repeated loosening, tightening, and measuring. So far as is known, none of the ring machines that are currently available make provision for moving a portion of the ring machine in a direction substantially parallel to the Z axis to square the ring machine up to the surface to be reconditioned. Due to the weight of the ring machine (ring machines for use on modest size tubular members, for instance, for use in reconditioning the surface of a twenty inch pipe, weigh several hundred pounds, and those used on large diameter pipe approach a ton), the ring machine cannot easily be moved in any direction. For that reason, the process of squaring the ring machine up to the surface to be reconditioned is usually accomplished by loosening one or more of clamps and hammering on the frame of the ring machine near the clamp that has been loosened to “bump” that portion of the frame a short distance in the desired direction. This process is not very precise, and it relies on the weight of the ring machine and the slight loosening of the clamp to prevent drastic movement of the ring machine relative to the surface to be reconditioned, neither of which results in predictable movement and/or limitation of movement, in a direction substantially parallel to the Z axis.

There is, therefore, a need for a ring machine, and a method of mounting a ring machine to a tubular member for reconditioning a surface that allows precise movement of the ring machine so as to square the ring machine up to the surface to be reconditioned, and it is an object of the present invention to provide such a machine and such a method.

The second limitation of known ring machines to which the present invention is directed is in the mounting of the cutting tool (which bears against the surface to be reconditioned to cut that surface as it is moved across the surface by the ring machine) to the ring machine. The cutting tool must be mounted to the ring machine in such a way that precise positioning can be achieved and, once positioned, it cannot change position until moved by the operator. Further, the mount must be secure enough to resist vibration, or chattering, of the cutting tool as a result of the impact of the cutting tool on irregularities on the surface to be reconditioned as the cutting tool is moved across that surface. It is recognized that it is impossible to prevent all chattering, but such movement must be minimized to produce a satisfactorily reconditioned surface, and it is well known that the best reconditioned surfaces are those that were reconditioned with a cutting tool with minimal chatter. At the same time, the cutting tool must be capable of being replaced quickly and then accurately re-positioned relative to the cutting surface so as to resume re-facing operations at the same depth of cut such that precision in mounting is an important factor in the mounting of the cutting tool to the ring machine.

There is, therefore, a need for an apparatus and method for reconditioning a surface of a tubular member that resists vibration, or chatter, of the cutting tool during reconditioning operations while still allowing quick replacement of the cutting tool and accurate positioning of the cutting tool relative to the surface to be reconditioned, and it is an object of the present invention to provide such an apparatus and method.

Another object of the present invention is to provide an apparatus and method for reconditioning the surface of a tubular member that produces a smooth reconditioned surface.

Another object of the present invention is to provide an apparatus and method for reconditioning the surface of a workpiece with a cutting tool in which the cutting tool is constantly biased against, or drawn to, the ring machine so as to increase the rigidity of the mount of the cutting tool relative to the ring machine.

Yet another object of the present invention is to provide an apparatus and method in which the cutting tool used to recondition the surface of a workpiece is quickly and easily replaced so as to increase the speed of the reconditioning operation.

Other objects, and the advantages, of the present invention will be made clear to those skilled in the art by the following description of the presently preferred embodiments thereof.

### SUMMARY OF THE INVENTION

These objects are achieved by providing an apparatus for reconditioning the surface of a workpiece comprising a frame having a shape approximating the shape of the workpiece having a first portion that is fixed relative to the workpiece and a second portion that is movable relative to the workpiece. A plurality of blocks are mounted to the first portion of the frame, each block having a threaded bolt extending therethrough and a jaw mounted to the end of the bolt for engaging the workpiece when rotated to extend the bolt out of said block to the workpiece. The jaw is movable relative to the cylinder in a direction substantially perpendicular to the axis of the bolt to which the cylinder and jaw are mounted. A drop plate is mounted to the second portion of the frame and a compound is detachably mounted to the drop plate for mounting a cutting tool thereon for reconditioning the surface of the workpiece when the second portion of the frame is moved relative to the workpiece.

The present invention also provides a method for moving a ring machine relative to the surface of a workpiece to reconditioned to square the ring machine up to the surface comprising the steps of frictionally engaging the outside surface of the workpiece by extending a jaw from a block, the block being integral with the ring machine and, while the jaw is frictionally engaged to the outside surface of the workpiece, moving the jaw in a direction substantially perpendicular to the direction the jaw was extended into engagement with the outside diameter of the workpiece, thereby moving the ring machine relative to the workpiece.

In another aspect, the present invention provides an apparatus for reconditioning the surface of a workpiece comprising a frame for detachably mounting to a workpiece having a surface to be reconditioned, the surface to be reconditioned defining X and Y axes lying substantially in the plane of the surface to be reconditioned and a Z axis substantially perpendicular to the X-Y axes. First means is mounted to the frame for moving the frame relative to the workpiece in directions having a component substantially parallel to the X-Y axes when the frame is mounted to the workpiece for aligning the frame with the workpiece; and second means is mounted to the frame for moving the frame in a direction having a component that is substantially parallel to the Z axis when the frame is mounted to the workpiece for squaring the frame up to the workpiece.

Also provided is a mount for a cutting tool comprising a compound having a tool holder mounted thereto with a member formed on the compound and having a beveled surface thereon. The apparatus also comprises a pin shaped to engage the beveled surface of the member formed on the compound and a drop plate for mounting to a carriage. The drop plate is provided with a hole therethrough for receiving the beveled member and a hole for receiving the pin, the pin locking the compound to the drop plate by engaging the beveled surface of the member when received in the hole in the drop plate.

### BRIEF DESCRIPTION OF THE DRAWINGS

FIG. 1 is a front perspective view of a preferred embodiment of an apparatus for re-facing a surface that is constructed in accordance with the teachings of the present invention and that is mounted to the outside diameter of a pipe.

FIG. 2 is a back perspective view of the apparatus of FIG. 1.

FIG. 3 is a perspective view of a preferred embodiment of a clamp for mounting the presently preferred embodiment shown in FIG. 1 to the O.D. of a pipe or other tubular member.

FIGS. 4 and 5 are side, elevational views of the clamp of FIG. 3.

FIG. 6 is an exploded, perspective view of the clamp of FIG. 3.

FIG. 7 is a perspective view of a presently preferred embodiment of a mount for a cutting tool for use with the presently preferred embodiment shown in FIG. 1.

FIG. 8 is a sectional view, taken along the lines 7-7, of the mount of FIG. 6.

FIG. 9 is an exploded, perspective view of the mount of FIG. 6.

### DETAILED DESCRIPTION OF THE PREFERRED EMBODIMENT

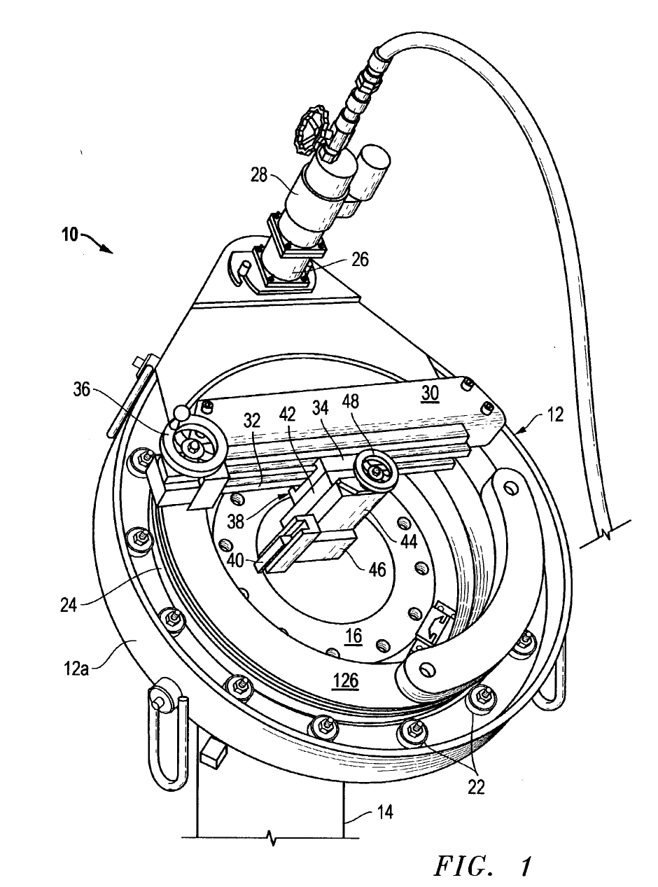

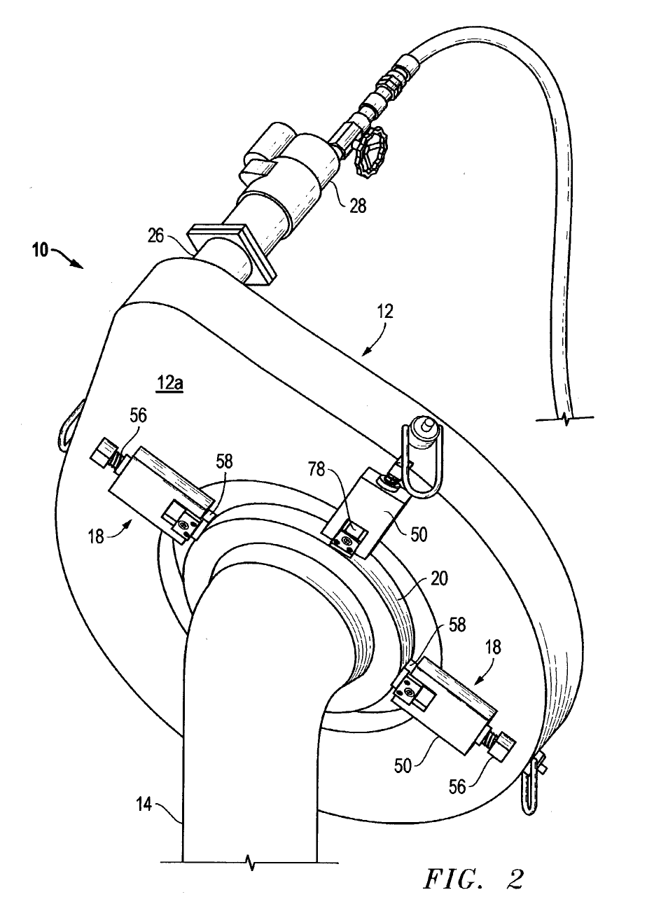

Referring first to FIGS. 1 and 2, a preferred embodiment of an O.D. mount facing machine constructed in accordance with the teachings of the present invention is indicated generally at reference numeral 10. The apparatus 10 comprises a frame 12 shaped to approximate the shape of a tubular member, or workpiece, 14 having a surface 16 thereon to be reconditioned, or re-faced. As set out in more detail below, frame 12 is comprised of first and second portions 12a and 12b, the portion 12a being provided with means, in the form of a plurality of clamps 18, for engaging the surface, or outside diameter (O.D.), 20 of workpiece 14, and the portion 12b being movable relative to the portion 12a. The stationary, or fixed, portion 12a of frame 12 is provided with a plurality of bearings 22 against which the outside surface 24 of the second portion 12b of frame bears and a mount 26 for an air motor 28. Although not visible in either of FIGS. 1 or 2, the mount 26 is also provided with an idler for a belt that is wrapped around the rotatable portion 12b of frame 12 to rotate the portion 12b relative to the stationary portion 12a of frame 12 under power from the air motor 28. Those skilled in the art will recognize that other drive arrangements known in the art may also be utilized for rotating frame portion 12b relative to frame portion 12a.

A cross-arm 30 is mounted to the rotating portion 12b of frame 12 and a track 32 is provided on one side of cross-arm 30 with a carriage 34 running on track 32. The position of carriage 34 on track 32 is controlled by rotation of adjustment wheel 36, which turns a worm gear (not visible in the figures) for moving the carriage 34 along track 32 in a manner known in the art. The carriage 34 is provided with apparatus, indicated generally at reference numeral 38, for mounting a cutting tool 40 thereto. In the embodiment shown, apparatus 38 is comprised of a drop plate 42 and compound 44, the latter providing a mount for tool holder 46, all to be described in more detail below. The height of the cutting tool 40 relative to the surface 16 of workpiece 14 is adjusted by turning the wheel 48 in a manner that is also known in the art.

Referring now to FIGS. 2-6, the clamps 18 and their function will now be described in detail. Each clamp 18 is comprised of a block 50 that is provided with a plurality of holes 52 for receiving bolts (not shown) for mounting clamp 18 to the first portion 12a of frame 12. Each block 50 is also provided with a bore 54 extending longitudinally therethrough for receiving a threaded bolt 56 having a jaw 58 mounted to the end thereof and extendible therefrom upon rotation of bolt 56 relative to block 50. As best shown in FIG. 5, bolt 56 is provided with two sets of threads, a first set of right-hand threads 60 and a second set of left-hand threads 62. The right-hand threads 60 of bolt 56 mate with the threads 64 on the inside surface of a bushing 66 that is received within the bore 54 through block 50 and pinned in place in block 50 by the tapered dowels 68 that are received in the holes 70 that extend down into block 50. When bushing 66 is assembled to block 50 in bore 54 and the dowels 68 are inserted into the holes 70 in block 50, the dowels 68 are received in the channels 72 formed on the outside surface 74 of bushing 66. The channels 72 form flats that, when engaged by dowels 68, prevent rotation of bushing 66 relative to block 50 when bolt 56 is rotated.

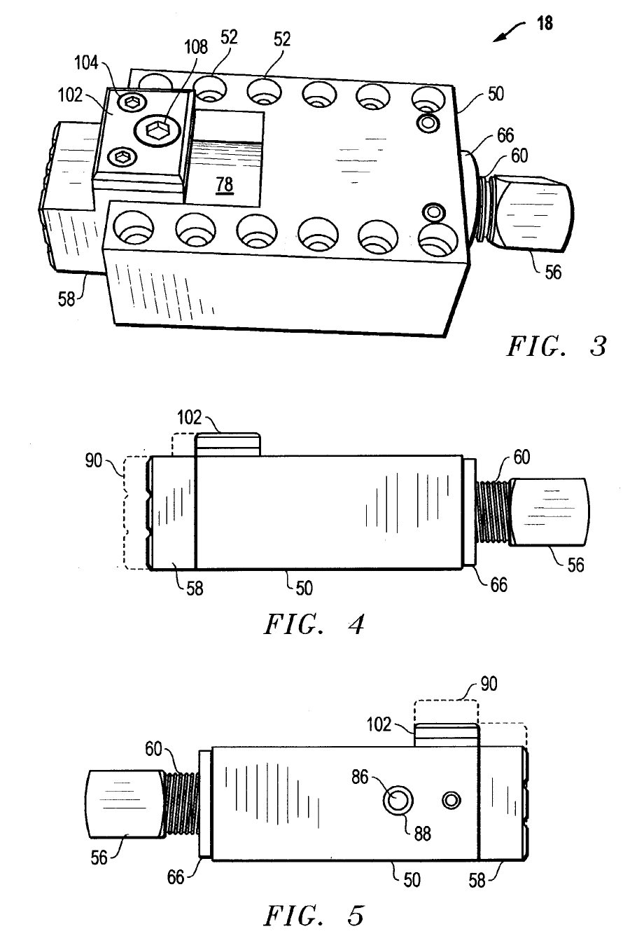

The left-hand threads 62 of bolt 56 mate with the threads 76 inside the cylinder 78 that is also received within the bore 54 through block 50. Cylinder 78 is comprised of a barrel 80 in which the bolt 56 is received (on the threads 76) and a head 82 to which jaw 58 is mounted The barrel 80 of cylinder 78 is provided with a keyway 84 for receiving an anti-rotation pin 86 that extends through the hole 88 (see FIG. 5) in the side of block 50. Anti-rotation pin 86 prevents rotation of cylinder 78 relative to block 50 when bolt 56 is rotated, thereby causing cylinder 78 to move through the bore 54 in block 50 to extend the jaw 58 mounted to the head 82 thereof out of the block 50 as shown in shadow lines 90 in FIG. 4 and into frictional engagement with the O.D. 20 of workpiece 14.

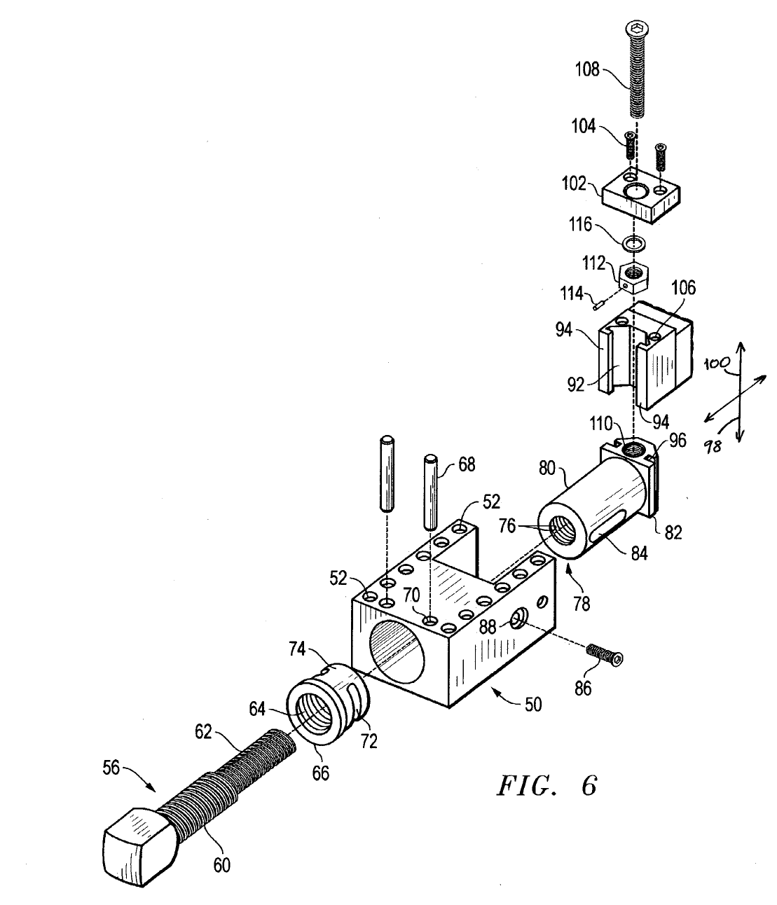

Also as best shown in FIG. 6, the head 82 of cylinder 78 is shaped to receive the mating surface 92 of jaw 58. Mating surface 92 is provided with opposed flanges 94 that are received within appropriately-sized slots 96 formed in the head 82 of cylinder 78 to form a track upon which jaw 58 rides up and down (in a manner to be described below) in the direction shown by arrow 98 that is substantially perpendicular to the direction (shown by arrow 100) the jaw 58 is extended upon rotation of bolt 56 into engagement with the O.D. 20 of workpiece 14. Jaw 58 is retained upon the track formed by the head 82 of cylinder 78 and the mating surface 92 of jaw 58 by a thrust plate 102 that is mounted to jaw 58 by the cap screws 104 that are received in the holes 106 formed in jaw 58. Movement of the jaw 58 in the direction of arrow 98 is accomplished by rotation of the socket head lead screw 108 that extends through thrust plate 102 and is received in the threaded bore 110 in jaw 58. A nut 112 received on lead screw 108 is pinned against rotation by a roll pin 114 that extends through nut 112 and into lead screw 108 and sandwiches a brass washer 116 against thrust plate 102 to allow rotation of lead screw 108 to cause the movement of jaw 58 along the threaded bore 110 in the direction of arrow 98, even while the jaw 58 frictionally engages the O.D. 20 of workpiece 14.

It will be apparent from the foregoing description that the movement of jaw 58 in the direction of arrow 98 by interaction of the lead screw 108 and the threaded bore 110 provides the apparatus 10 of the present invention with the ability to move the frame 12 in both the direction needed to center the frame on the center axis of the tubular member/workpiece 14 and the direction needed to square the frame 12 up with the surface 16 to be re-faced with the apparatus 10. In other words, if an X-Y-Z coordinate system is superimposed on the surface 16 of workpiece 14 with the X and Y axes lying substantially in the plane of surface 16 and the Z axis being substantially perpendicular to the X and Y axes, rotation of the bolt 56 extending through the block 50 of clamp 18 causes the frame 12 to move in a direction that is substantially parallel to either the X or Y axes, depending upon the location of the clamp 18 on frame 12. In actual practice, the movement of frame 12 relative to surface 16 is in a combination of X-Y directions depending upon which clamps 18 have been loosened and which clamps are then tightened by rotation of their respective bolts 56. This movement of frame 12 in directions having a component substantially parallel to the X and Y axes of this imaginary coordinate system is known in the art; it is the movement of the frame 12 relative to surface 16 in a direction having a Z component that is, so far as is known, not previously available in any O.D. mount facing machine. With reference to FIG. 6, the movement of frame 12 in directions having X and/or Y components is movement that is accomplished by movement of the cylinder 78 along the left-hand threads 62 of bolt 56 in the direction of arrow 100. Movement of frame 12 in a direction having a Z component (in the direction of arrow 98) is, as noted above, accomplished by movement of the jaw 58 along the threaded bore 110 upon rotation of lead screw 108 (see FIG. 5).

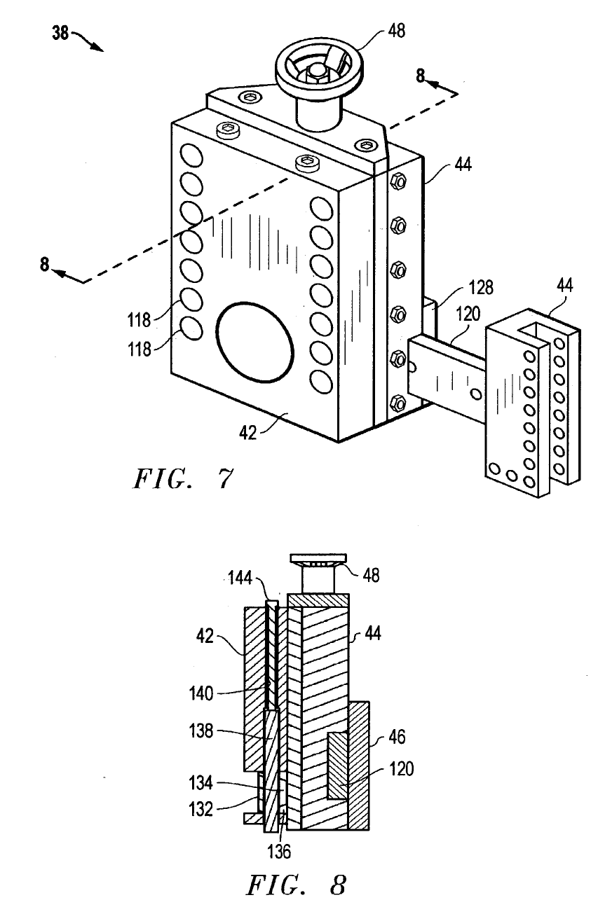

Referring now to FIGS. 7-9, a presently preferred embodiment of an apparatus for mounting a cutting tool (not shown in FIGS. 7-9; see reference numeral 40 in FIG. 1) is indicated generally at reference numeral 38. The mount 38 is comprised of a compound 44 having a tool holder 46 mounted thereto and a drop plate 42 for mounting, in the particular embodiment shown, to the carriage 34 that runs on the track 32 formed on cross-arm 30, and a plurality of holes 118 for receiving bolts (not shown) are provided in drop plate 42 for that purpose. However, those skilled in the art who have the benefit of this disclosure will recognize that the mount 38 of the present invention is not limited in its application to mounting a cutting tool to the carriage of an O.D. mount facing machine such as the apparatus 10 shown herein. Instead, it should be clear from this description that the mount 38 may be utilized to mount a cutting tool to any machine tool.

The tool holder 46 is mounted to compound 44 by sliding the tongue 120 formed on tool holder 46 into a matching groove 122 formed on compound 44 and locking the tool holder 46 in place with the screws 124 that are received through the holes 126 on cover plate 128 and through the holes 130 in the tongue 120. It will be recognized, however, by those skilled in the art that other ways are known in the art to mount the tool holder 46 to a compund such as the compound 44, or to other machine parts (not shown) and that the present invention is not limited to the particular mount shown in the figures.

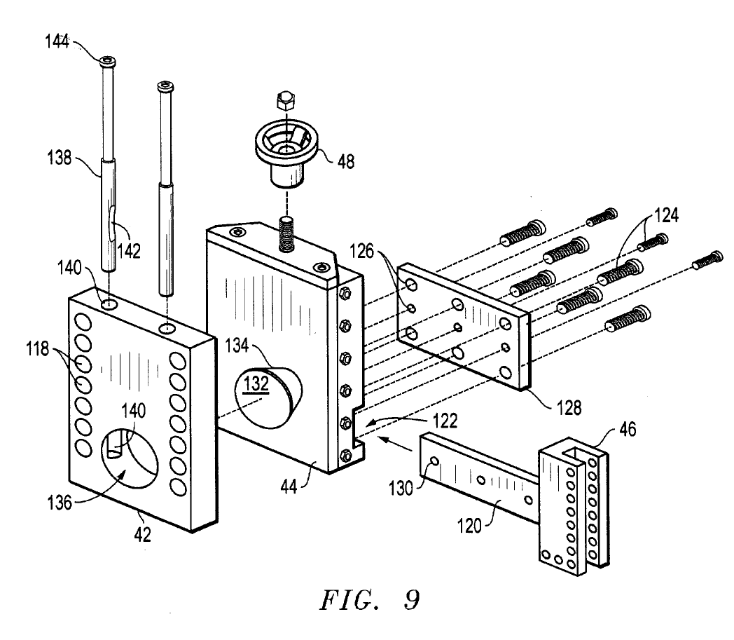

In more detail, a member 132 (see FIGS. 8 and 9) is formed on one side of compound 44 having a beveled, or undercut surface, indicated at reference numeral 134. In the embodiment shown, the member 132 takes the form of a round, or substantially rounded, projection extending from the side of compound 44 opposite the side to which tool holder 46 is mounted. Member 132 extends into a hole 136 in drop plate 42 when compound 44 is assembled to drop plate 42 and a draw pin 138, or in the case of the preferred embodiment shown in the figures, two draw pins 138, are pressed down into the bores 140 provided for that purpose in drop plate 42. As best shown in FIG. 9, a portion of each of the bores 140 intersects with the hole 136 so that the draw pins 138 engage the undercut surface 134 of member 132 to lock the compound 44 in place relative to drop plate 42. The engagement of the undercut surface 134 by draw pins 138 also biases the compound 44 against drop plate 42 to minimize the likelihood of relative movement therebetween. In addition to minimizing any such movement, this arrangement also provides for quick changeout of the cutting tool because the draw pins 138 are provided with a flat 142 positioned proximate the hole 136 when inserted into the bores 140 in drop plate 42 and a socket head 144 so that the draw pins 138 can be turned to allow the flared portion of member 132 to pass the draw pins 138. As a result of this construction, a light tap on compound 44 with a hammer (after rotating the draw pins 138) is generally all that is required to separate the compound from drop plate 42 even though the two parts are securely mounted to each other. Those skilled in the art will recognize from this description that the compound can be assembled to other machine tools having a hole 136 shaped and sized to receive the member 132 and bores 140 for receiving the draw pins 138 such that, when reference is made herein to a “drop plate” such as is shown at reference numeral 42, it is not intended to restrict the mount of the present invention to the mounting of a compound to a drop plate. For instance, it will be recognized by those skilled in the art that the hole 136 could be formed in the carriage 34 that rides on the cross-arm 30 of the O.D. mount facing apparatus 10 of the present invention and that the bores could be provided on that carriage for receiving the draw pins 138 such that the compound 44 is mounted directly to carriage 34 without having a drop plate such as the drop plate 42 interposed therebetween. For this reason, when reference is made herein to a mount for a cutting tool that includes a drop plate, it is to be understood that the phrase “drop plate” is being used in the generic sense to refer to any portion of a machine tool to which the cutting tool is to be mounted and that interacts with the compound in the manner described herein.

Those skilled in the art who have the benefit of this disclosure will recognize that certain changes can be made to the component parts of the apparatus of the present invention without changing the manner in which those parts function to achieve their intended result. For instance, with respect to the mount 38 described herein, the bores 140 in drop plate 42 need not extend vertically down through the drop plate 42; the draw pins 138 will function for the intended purpose of locking the compound 44 to drop plate 42 if the bores 140 extend from the sides of drop plate 42. It will also be recognized that the member 132 could extend from the surface of drop plate 42 into a hole formed in compound 44 and that the draw pins 138 could extend down through bores in the compound 44 to lock the drop plate and compound to each other. It will also be apparent that the member 132 need not necessarily be round; those skilled in the art will recognize that there may even be mechanical advantages to shaping the member 132 so that it is elongated (oval or elliptically-shaped, or even squared-off, when viewed in elevational view from the side that is assembled to drop plate 42) in a direction substantially parallel to the direction in which the draw pins 138 extend so as to increase the size of the undercut surface 134 against which draw pins 138 bear. With respect to the clamp 18 described herein, it will be recognized that the bushing 66 could be provided with a tapered surface and that the dowel pins 68 that lock the bushing 66 into the bore 54 through block 50 and resist rotation of bushing 66 could therefore interact in the same manner as the draw pins 138 interact with the beveled surface 134 of member 132 to prevent relative movement therebetween. Similarly, it may be advantageous to provide the dowel pins 68 with socket heads and flats in the same manner as the draw pins 138 for the same purpose. All such changes, and others which will be clear to those skilled in the art from this description of the preferred embodiments of the invention, are intended to fall within the scope of the following, non-limiting claims.

What is claimed is:

1. A method of moving a ring machine relative to the surface of a workpiece to reconditioned to square the ring machine up to the surface comprising the steps of:
frictionally engaging the outside surface of the workpiece by extending a jaw from a block, the block being integral with the ring machine; and
while the jaw is frictionally engaged to the outside surface of the workpiece, moving the jaw in a direction substantially perpendicular to the direction the jaw was extended into engagement with the outside diameter of the workpiece, thereby moving the ring machine relative to the workpiece.

2. The method of claim 1 wherein the jaw is extended by restraining a cylinder having a threaded bore therethrough for receiving a bolt against rotational movement relative to the block while rotating the bolt to cause the cylinder to travel on the bolt, the jaw being mounted to the cylinder.

3. Apparatus for reconditioning the surface of a workpiece comprising:
a frame having a shape approximating the shape of the workpiece with a first portion that is fixed relative to the workpiece and a second portion that is movable relative to the workpiece;
a plurality of blocks mounted to the first portion of said frame, each block having a threaded bolt extending therethrough and a jaw mounted to the end of the bolt for engaging the workpiece when rotated to extend the bolt out of said block to engage the workpiece, said jaw being movable relative to said cylinder in a direction substantially perpendicular to the axis of the bolt to which said cylinder and jaw are mounted; and
a cutting tool mounted to the second portion of said frame for reconditioning the surface of the workpiece when the second portion of said frame is moved relative to the workpiece.

4. The apparatus of claim 3 additionally comprising a bolt threadably engaging said cylinder for moving said jaw relative to said cylinder when turned.

5. The apparatus of claim 3 additionally comprising means for restraining said cylinder from rotation as said bolt is rotated.

6. Apparatus for reconditioning the surface of a workpiece comprising:
a frame for detachably mounting to a workpiece having a surface to be reconditioned, the surface to be reconditioned defining X and Y axes lying substantially in the plane of the surface to be reconditioned and a Z axis substantially perpendicular to the X axis;
first means mounted to said frame for moving said frame relative to the workpiece in directions having a component substantially parallel to the X and Y axes when said frame is mounted to the workpiece for aligning said frame with the workpiece; and
second means mounted to said frame for moving said frame in a direction having a component substantially parallel to the Z axis when said frame is mounted to the workpiece for squaring said frame up to the workpiece.

7. The apparatus of claim 6 wherein said first frame moving means comprises a plurality of clamps spaced around said frame, each said clamp having a jaw mounted thereto for extending into frictional engagement with the workpiece.

8. The apparatus of claim 7 wherein said second frame moving means comprises means for moving the jaw of one or more of said clamps in a direction substantially perpendicular to the direction the jaw is extended to engage the workpiece.

9. Apparatus for mounting a cutting tool comprising:
a compound adapted for mounting a tool holder thereto;
a member formed on said compound and having a beveled surface thereon;
a pin shaped to engage the beveled surface of the member formed on said compound;
a drop plate having a hole therethrough for receiving said beveled member and a hole for receiving said pin, said pin locking said compound to said drop plate by engaging the beveled surface of said member when received in the hole in said drop plate.

10. The apparatus of claim 9 wherein said pin additionally comprises a flat so that, when the pin is rotated relative to said drop plate, the pin is disengaged from the beveled surface of said member.

11. The apparatus of claim 9 wherein said drop plate is provided with a second hole for receiving a second pin for engaging the beveled surface of said member.
